(19) United States
(12) Patent Application Publication
(10) Pub. No.: US 2016/0040784 A1
(43) Pub. Date: Feb. 11, 2016

(54) METALLIC FLAT GASKET AND A METHOD FOR PRODUCTION OF SAME

(71) Applicant: ElringKlinger AG, Dettingen (DE)

(72) Inventor: Ulrich Werz, Dettingen (DE)

(73) Assignee: Elring Klinger AG

(21) Appl. No.: 14/921,537

(22) Filed: Oct. 23, 2015

Related U.S. Application Data
(63) Continuation of application No. PCT/EP2014/057954, filed on Apr. 17, 2014.

(30) Foreign Application Priority Data
Apr. 26, 2013 (DE) 102013104269.4

(51) Int. Cl. F16J 15/08; F02F 11/00

(52) U.S. Cl. CPC F16J 15/0818; F02F 11/002; F16J 15/0887

(57) ABSTRACT

A flat gasket including a sealing plate having a media-passage opening, a spring steel functional layer with a sealing bead surrounding the media-passage opening, and a second sealing layer formed of a deformable second steel sheet, which has an original thickness and an original hardness and around the media-passage opening forms an annular zone, which has at least one annular region that is thickened compared with the original thickness and forms an annular groove for engagement of the sealing bead, wherein the second sealing layer in the thickened annular region has a greater hardness than the original hardness, and wherein the annular zone has (a) one thickened annular region, into which an annular groove is impressed on at least one side of the second sealing layer, or (b) in the radial direction relative to the media-passage opening, two thickened annular regions spaced apart to form the annular groove between them.

### CROSS-REFERENCE TO RELATED APPLICATIONS

The present application is a continuation of international application number PCT/EP2014/057954 filed on Apr. 17, 2014, which claims priority to German patent application number 10 2013 104 269.4, filed Apr. 26, 2013, the entire specification of both being incorporated herein by reference.

### FIELD OF THE INVENTION

The invention relates to a metallic flat gasket comprising a sealing or gasket plate having at least one media-passage opening and having, in the region of the media-passage opening, at least one spring steel functional layer formed of a first steel sheet with a sealing bead that surrounds the media-passage opening and is formed as a full bead with a bead crest arranged between two bead feet, and also a second sealing or gasket layer, which is directly adjacent to the functional layer and is formed of a second steel sheet, which can be deformed more easily compared with spring steel, which second sealing layer has, around the media-passage opening, an annular zone adjacent thereto and, radially outwardly adjacently to said annular zone relative to the media-passage opening, has an original thickness and an original hardness of the second steel sheet, wherein the second sealing layer in the annular zone has at least one annular region that is thickened compared with the original thickness of the second steel sheet, which thickened annular region extends along the sealing bead in a plan view of the sealing plate.

The invention also relates to a method for producing a flat gasket of this type.

### BACKGROUND OF THE INVENTION

In the case of a flat gasket of this type with a multi-layer sealing plate, the media-passage opening naturally extends through all sealing layers that the sealing plate has in the region of this media-passage opening.

A spring steel is to be understood to be a steel in which the ratio of yield point Rₑ or alternatively elastic limit R_{p0.2} to tensile strength Rₘ is greater than 0.85 (85%).

A functional layer is understood by a person skilled in the art of gaskets to mean a sealing layer having at least one bead, which can be at least substantially reversibly flattened when the flat gasket is installed between mutually opposed surfaces of components that are to be sealed with respect to one another, but particularly during operation of the flat gasket, such that the height of the bead, starting from the state thereof when the flat gasket is not pressed, is reduced, wherein the spring steel sheet of the functional layer is deformed at least substantially only in the elastic region of the spring steel.

Depending on the design, dimensioning and arrangement of the thickened annular region of a flat gasket of the type in question and also depending on the design and thickness of the second sealing layer, a person skilled in the art of gaskets will understand this to mean a spacer layer and/or what is known as a stopper layer and/or what is known as a carrier sheet, which determine and/or increase the thickness of the flat gasket in the installed state, wherein the following should be noted in this regard: Particularly in the case of flat gaskets of the type in question for internal combustion engines, the media-passage opening of these gaskets being intended for the hot and pressurized combustion gases, the gasket fabricator often seeks to form the flat gasket, therefore in particular a cylinder head gasket, such that the compressive forces acting on the installed flat gasket are highly concentrated on the sealing plate region directly bordering the media-passage opening and surrounding said opening, for which reason this sealing plate region is designed such that the elements of the sealing plate arranged in said region one above the other when the flat gasket is installed are pressed en bloc, and there the sum of the material thicknesses of the aforementioned sealing plate elements is greater than in a sealing plate region arranged further radially outwardly relative to the media-passage opening—in the case of a cylinder head gasket and a media-passage opening serving as a combustion chamber opening, a person skilled in the art of gaskets will refer to a gasket portion of increased thickness surrounding the combustion chamber opening. It is also noted that in the case of flat gaskets of the type under discussion a deformation limiter (usually referred to as a stopper) is often associated with the sealing bead and has the task of protecting the sealing bead, during operation of the flat gasket, against an excessive flattening, but particularly against an excessively high time variation (dynamic) of the bead height, i.e. protecting against deformation of the spring steel sheet of the functional layer in the resilient region of the spring steel during the course of the time variation of the bead height, and also against significant plastic deformation of the spring steel. In this context it is noted that, when installing a flat gasket of the type under discussion, i.e. as the flat gasket is clamped between two components that are to be sealed with respect to one another, such as a cylinder head and an engine block, the functional layer consisting of a spring sheet steel, in the region of a sealing bead, is not only deformed in the resilient region of the spring steel, but is also plastically deformed to a small extent, such that, following the expansion of a flat gasket, the sealing bead has a height that is slightly smaller than the original bead height. It should also be mentioned that, when, in the case of a flat gasket of the type under discussion, the stopper is arranged on the second sealing layer, this is usually referred to as a stopper layer.

U.S. Pat. No. 6,499,743 B2 discloses a triple-layer metallic cylinder head gasket comprising two outer functional layers and an inner sealing layer arranged therebetween and referred to as a carrier layer, which is to serve to provide a gasket portion of increased thickness and also is to perform a stopper function for the two functional layers, wherein this cylinder head gasket is intended and designed for what is known as an engine with cylinder liners, in which a cylinder liner enclosing each combustion chamber is inserted into the cylinder block for each of said combustion chambers. The two functional layers each have, above each cylinder liner, a sealing bead that runs around the combustion chamber concerned and that is formed as a full bead, wherein the two sealing beads lie one above the other in the axial direction of the cylinder liner and protrude in the direction of the carrier layer, i.e. they abut with their bead crests against the carrier layer when the cylinder head gasket is installed. Irrespective of the fact that the carrier layer for each combustion chamber has two thickened annular regions with round cross section, the carrier layer has the same sheet thickness everywhere and therefore has two flat main surfaces that are parallel to one another. A thickened annular region arranged radially inwardly relative to the combustion chamber borders the combustion chamber directly and lies (as considered in the direction of the axis of the cylinder liner) above the cylinder liner and radially inwardly of the sealing beads at a radial distance from the latter, which are likewise arranged above the cylinder liner, and in accordance with the basic principle of U.S. Pat. No. 6,499,743 B2 the radially inner thickened annular region above the cylinder liner is to gasket the gasket gap between the cylinder head and the cylinder block provided with the cylinder liner, i.e. the radially inner thickened region forms a gasket portion of increased thickness. The radially outer thickened annular region is arranged radially outside the sealing beads and the cylinder liner above the cylinder block and in accordance with the basic principle of U.S. Pat. No. 6,499,743 B2 is to limit the compressive forces acting on the sealing beads of the installed cylinder head gasket. The way in which the carrier layer is to be provided with the two thickened annular regions cannot be derived from U.S. Pat. No. 6,499,743 B2.

A further triple-layer metallic cylinder head gasket comprising two outer functional layers and an inner sealing layer arranged therebetween and referred to as a spacer layer is presented in EP 1 271 016 B1, and in this known cylinder head gasket as well the sealing beads of the functional layers each surrounding a combustion chamber opening protrude in the direction of the inner sealing layer, i.e. the spacer layer. In this cylinder head gasket a height-profiled stopper, i.e. a stopper that in the peripheral direction of the adjacent combustion chamber opening has a height profile, i.e. different heights and/or thicknesses (see paragraph [0005]), is to be produced with minimal outlay for a sealing bead of a functional layer or the sealing bead of each functional layer. For this purpose an auxiliary sheet in the form of a sheet ring surrounding the respective combustion chamber opening is provided on the side of the spacer layer facing towards the respective functional layer and, as considered in the direction of the axis of the combustion chamber opening, extends radially outwardly from the combustion chamber opening edge until beyond the sealing bead and is pressed by embossing into the spacer layer via an annular region which is opposite the sealing bead in question and of which the radial width is slightly greater than the radial width of the sealing bead, more specifically with the formation of likewise annular indentations corresponding to one another in the spacer layer and in the auxiliary sheet. Annular regions of the auxiliary sheet, which abut the spacer layer outside the indentations and are each provided by the embossing process by means of an accordingly shaped embossing tool with a height profile, more specifically together with the spacer layer, radially inside and radially outside the sealing bead are in turn formed in this way (in a plan view of the cylinder head gasket) on each side of the sealing bead and of the indentations, such that these regions radially inside and radially outside the sealing bead each form a height-profiled stopper for the sealing bead, which, when the cylinder head gasket is pressed, engages via its bead crest in the indentation of the auxiliary sheet—in this case a person skilled in the art of gaskets will refer to a double stopper for the sealing bead. As is clear from FIG. 2 in conjunction with paragraph [0016] of EP 1 271 016 B1, the spacer layer, of which the thickness is a multiple of the thickness of the auxiliary sheet, is plastically deformed during the embossing process, both in the region of the indentation of said spacer layer and between this indentation and the combustion chamber opening. It is essential that the spacer layer does not at any point have a thickened annular region, but also does not at any point of its region provided with the auxiliary sheet have a thickness that is greater than the original thickness of the spacer layer, specifically the thickness thereof radially outside the auxiliary layer.

DE 195 48 237 A1 presents a further triple-layer cylinder head gasket comprising two functional layers and a spacer layer arranged therebetween, towards which the sealing beads of the two functional layers protrude. In order to be able to adjust what is known as the installation thickness, i.e. the thickness of the cylinder head gasket once this has been installed, without the use of differently formed functional layers, more specifically only by the use of spacer layers of different thickness, the spacer layer has a thickened annular region around a combustion chamber opening and directly bordering same, in which thickened annular region the spacer layer is thicker than in its other regions, and in addition the spacer layer has, radially outside this thickened annular region and on each of the two sides thereof, an annular groove, with which the sealing bead of the adjacent functional layer engages via its bead crest when the cylinder head gasket is pressed. As is clear from DE 195 48 237 A1 (see FIGS. 2 to 4 thereof and also column 1, lines 59 to 62), this thickened annular region provided on the spacer layer is produced either in that the actual spacer layer is deformed by forging, i.e. the spacer layer is deformed in the hot state of the metal, or the spacer layer is provided with annular overlays or a sheet layer is placed on the spacer layer and is folded back on itself around the combustion chamber opening and directly bordering said opening. This known cylinder head gasket thus has only a single thickened annular region bordering the combustion chamber opening, and this thickened annular region serves in this cylinder head gasket to produce a gasket portion of increased thickness and in addition is to prevent the sealing beads from being able to be pressed flat.

### SUMMARY OF THE INVENTION

The problem addressed by the present invention is that of forming a metallic flat gasket of the type defined in the introduction, for the second sealing layer of which a relatively ductile and therefore easily deformable steel sheet is used, such that said flat gasket via its second sealing layer forms a double stopper for the sealing bead of the at least one functional layer, which double stopper is very resistant to deformation in respect of the compressive forces acting on the installed flat gasket (in the direction perpendicular to the sealing plate plane) and can preferably be produced such that relatively little space is required for the double stopper in the radial direction relative to the media-passage opening (particularly in the case of flat gaskets, in particular cylinder head gaskets, for modern internal combustion engines there is often insufficient space for a conventional double stopper between the media-passage opening and a passage opening or a plurality of passage openings adjacent thereto).

Proceeding from a metallic flat gasket of the type defined in the introduction, this object can be achieved in accordance with the invention in that the at least one thickened annular region, on the side of the second sealing layer facing towards the functional layer, forms an annular groove, in which the sealing bead engages with its bead crest when the flat gasket is pressed, wherein the second sealing layer in the at least one thickened annular region produced by deforming some sections of the second steel sheet has a greater hardness, based on a strain hardening in some sections of the second steel sheet on account of the deformation, than the original hardness of the second steel sheet, and wherein
(a) the annular zone has only one thickened annular region, in which an annular groove is impressed on at least one side of the second sealing layer, or
(b) the annular zone has, in the radial direction relative to the media-passage opening, two thickened annular regions arranged one behind the other and spaced apart from one another which form the annular groove between them.

As will become clear from the following description, the flat gasket according to the invention comprising an annular zone according to the above-mentioned feature (a) and/or comprising an annular zone according to the above-mentioned feature (b) is characterized in preferred embodiments in that the second sealing layer is cold-formed in its corresponding layer region or its corresponding layer regions in order to produce the thickened annular region or the thickened annular regions and is thus provided with a hardness (specifically on account of a strain hardening) in this layer region or in these layer regions that is greater than the original hardness of the second steel sheet.

Where reference is made above to the fact that when the flat gasket is pressed the sealing bead engages with its bead crest in the annular groove, this may also mean that when the gasket is pressed the sealing bead lies only over part of its height within the annular groove. This could be the case when, with the flat gasket installed, the sealing bead is in what is known as a main pressure path (in which it provides a sealing function and also transfers forces) and the double stopper is not pressed in each phase of the sealing operation, i.e. does not bear continuously against the adjacent functional layer on one or both sides of the sealing bead. If, by contrast, the gasket is in what is known as a shunt pressure path (in which it provides solely a sealing function), the double stopper is usually always pressed on both sides against the adjacent functional layer in each phase of the sealing operation.

If, in the case of the flat gasket according to the invention the second sealing layer has two thickened annular regions arranged at a radial spacing from one another and produced independently of or separately from one another, it has, between these annular regions, preferably at least approximately the original thickness and also the original hardness of the second steel sheet; in such an embodiment the second sealing layer has at least substantially not been deformed between the thickened annular regions—between the thickened annular regions there is no need for an increased hardness of the second sealing layer caused by a strain hardening.

When producing multi-layer metallic cylinder head gaskets comprising two functional layers and a further sealing layer arranged therebetween, towards which further sealing layer a sealing bead of the two functional layers enclosing a combustion chamber opening protrudes, it is already known to form the further sealing layer as a stopper layer, which has (in a plan view of the cylinder head gasket), between the combustion chamber opening and the sealing beads of the two functional layers arranged above one another, a thickened annular region enclosing the combustion chamber opening and acting as a stopper for the sealing beads (see DE 10 2006 021 499 A1), wherein, for the further sealing layer, a steel sheet that can be more easily deformed compared with the spring steel of the functional layers is used and is provided with the thickened annular region as follows.

In a first embodiment of the production method from DE 10 2006 021 499 A1 a temporary passage opening concentric with the combustion chamber opening to be provided in the further sealing layer is formed in the steel sheet for said further sealing layer, the diameter of said passage opening being smaller than that of the combustion chamber opening, whereupon the steel sheet is compressed from the edge of the temporary passage opening such that the steel sheet, in an annular zone bordering the aforementioned edge, obtains a greater thickness than the original thickness of this steel sheet in order to produce a blank of the thickened annular region, whereupon this blank is brought by means of embossing into the form of the thickened annular region (see FIGS. 4A to 4D of DE 10 2006 021 499 A1). The thickened annular region serving as a stopper then has a substantially rectangular cross section and protrudes beyond both primary surfaces of the further sealing layer, which is flat for the rest and has the same thickness everywhere.

In a second embodiment of the known production method as well, a temporary passage opening concentric with the combustion chamber opening to be produced is formed in the steel sheet used for the further sealing layer, the diameter of said passage opening being smaller than that of the combustion chamber opening, whereupon a bead-like bulge enclosing the temporary passage opening annularly is impressed into the steel sheet such that here the outer edge of the temporary passage opening is drawn radially outwardly, whereupon the region of the steel sheet provided with this bulge is brought by embossing into the form of the thickened annular region serving as a stopper (see FIGS. 5A to 5D of DE 10 2006 021 499 A1). In this embodiment the region of the steel sheet provided with the bulge thus forms a sort of blank of the thickened annular region to be produced and serving as a stopper, and once this blank has been deformed by embossing, specifically by compression perpendicularly to the plane of the further sealing layer, and has been brought into the form of the thickened annular region serving as a stopper, said thickened annular region on the side thereof corresponding to the concave side of the bulge forming the blank has a functionless, only slight annular indentation surrounding the combustion chamber opening and therefore has a substantially rectangular cross section, of which the thickness is greater than that of the further sealing layer, which is flat for the rest and has the same thickness everywhere, i.e. the original thickness of the steel sheet used for the further sealing layer.

In the case of the cylinder head gaskets presented by DE 10 2006 021 499 A1, the further sealing layer arranged between the two functional layers thus has, in the region of the combustion chamber opening, just a single thickened annular region serving as a stopper, which thickened annular region is arranged, relative to the combustion chamber opening, radially inside the sealing beads of the two functional layers for which the thickened annular region performs a stopper function.

Particularly when, with the flat gasket according to the invention, the sealing bead is in the shunt pressure path, the second sealing layer is preferably formed such that the width of the annular groove is greater than the width of the sealing bead so that the latter, when the gasket is installed and/or in sealing operation, cannot be damaged by the edges of the annular groove. In this respect it is also advantageous when the side walls of the annular groove at the upper, free edges thereof are rounded (in a cross section through the second sealing layer), i.e. are provided with a radius. As will also become clear from the following, the width of the annular groove however may also be the same size as or smaller than the width of the sealing bead. In addition, the above is also true for the case of a sealing bead in what is known as the main pressure path, for which it may be recommended to select the width of the annular groove so as to be smaller than the width of the sealing bead.

Irrespective of whether the sealing bead is in the shunt or main pressure path in the case of the flat gasket according to the invention, it is recommended to form the flat gasket such that the depth of the annular groove is dimensioned such that when the flat gasket is pressed and when a functional layer bears in sealing operation on each side of the annular groove against the at least one thickened annular region, the sealing bead is deformed at least substantially only reversibly, i.e. elastically. In preferred embodiments of the flat gasket according to the invention the radially inner part of the at least one thickened annular region relative to the media-passage opening serves substantially to form a portion of increased thickness of the flat gasket in the region thereof directly adjoining the media-passage opening, that is to say in the case of a cylinder head gasket i.e. of a portion of increased thickness, the flat gasket can still be designed such that the at least one thickened annular region on both sides of the sealing bead forms a deformation limiter for this, such that the sealing bead is not damaged in sealing operation by excessive flattened portions.

The invention also relates to a method for producing a metallic flat gasket comprising a sealing plate having at least one media-passage opening, which sealing plate has, in the region of the media-passage opening, at least one spring steel functional layer formed of a first steel sheet with a sealing bead that surrounds the media-passage opening and is formed as a full bead, and also a second sealing layer, which is directly adjacent to the functional layer and is formed of a second steel sheet, which is more easily deformable compared with spring steel, which second sealing layer has, around the passage opening, an annular zone adjacent thereto and, radially outwardly adjacently to said annular zone relative to the media-passage opening, has an original thickness of the second steel sheet, wherein the second sealing layer in its annular zone has at least one annular region that is thickened compared with the original thickness of the second sheet steel, which thickened annular region extends along the sealing bead in a plan view of the sealing plate and on the side of the second sealing layer facing towards the functional layer forms an annular groove, in which the sealing bead engages with its bead crest when the flat gasket is pressed; in accordance with the invention, in order to produce the thickened annular region, a temporary passage opening concentric with the media-passage opening to be produced in the second steel sheet used for the second sealing layer is made in said second steel sheet, the diameter of said temporary passage opening being smaller than that of the media-passage opening, whereupon the second steel sheet is compressed from the edge of the temporary through-opening and in so doing undergoes an enlargement of its material thickness, such that a blank of the thickened annular region is produced, and this blank is brought by embossing into the form of the thickened annular region.

Alternatively, in order to produce a thickened annular region, a temporary passage opening concentric with the media-passage opening to be produced in the second steel sheet used for the second sealing layer can be made in said second steel sheet, the diameter of said temporary passage opening being smaller than that of the media-passage opening, whereupon a bulge surrounding the temporary passage opening in an annular fashion is impressed into the second steel sheet such that here the outer edge of the temporary passage opening is drawn radially outwardly, whereupon the region of the second steel sheet provided with the bulge is brought by embossing into the form of the thickened annular region.

If the second sealing layer has only one thickened annular region, the annular groove is impressed into this thickened annular region in preferred embodiments of the method according to the invention.

If two thickened annular regions are produced in the second steel sheet by means of one and/or the other embodiment of the method according to the invention, preferably one behind the other and spaced apart from one another radially relative to the media-passage opening, these form the annular groove between them; in this case it is recommended to configure the production method such that the radially inner thickened annular region relative to the media-passage opening is produced by compression of the second steel sheet and the radially outer thickened annular region is produced by embossing of a bulge (in each case with a subsequent embossing of the deformed region of the second steel sheets in order to provide this region with the form of the thickened annular region). However, it may also be advantageous to produce each of the thickened annular regions by embossing of a bulge and subsequent embossing of the deformed region of the second steel sheet.

### BRIEF DESCRIPTION OF THE DRAWINGS

Further features, details and advantages of the flat gasket according to the invention and of the production method according to the invention will emerge from the accompanying drawings of some embodiments of the invention and also the following description of these embodiments; in the drawings

FIG. 1: shows a plan view of part of a flat gasket according to the invention formed as a cylinder head gasket;

FIG. 2A shows a heavily simplified and schematized sectional illustration of a first embodiment of the invention, more specifically a section along the line 2-2 in FIG. 1;

FIGS. 2B to 2D: show sectional illustrations corresponding to FIG. 2A of a second, third and fourth embodiment of the invention;

FIGS. 3A to 3D: show an illustration of a number of steps of a method according to the invention for producing the inner layers shown in FIGS. 2B to 2D of a cylinder head gasket according to the invention, of which the inner layer for a combustion chamber opening has only a single thickened annular region, into which on both sides an annular groove is impressed for the sealing bead of the respective adjacent functional layer; and

FIGS. 4A to 4D: show illustrations corresponding to FIGS. 3A to 3D of a number of steps of a method according to the invention for producing the right thickened annular region according to FIG. 2A of the inner layer of the cylinder head gasket shown in FIG. 2A.

### DETAILED DESCRIPTION OF THE INVENTION

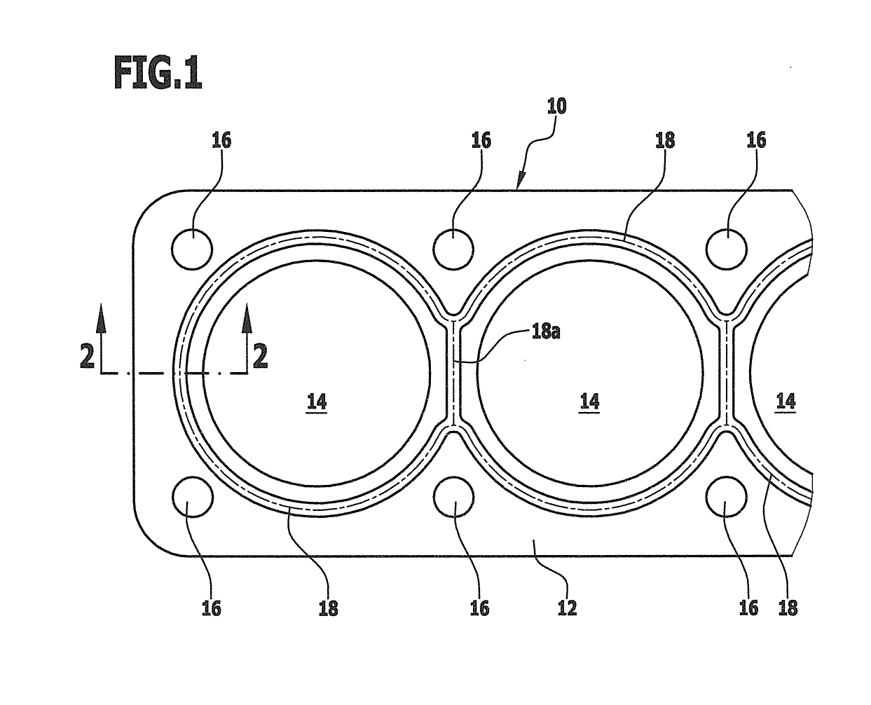

A multi-layer cylinder head gasket according to the invention but illustrated only in part in FIG. 1 in a plan view has a sealing plate 10 comprising an upper functional layer 12 (visible in FIG. 1), a plurality of combustion chamber openings 14, and a plurality of screw holes 16 for the passage of cylinder head screws.

Sealing beads 18 are impressed into the upper functional layer 12, and also into a lower functional layer not visible in FIG. 1, each of which sealing beads surrounds a combustion chamber opening 14 and is arranged at a radial spacing from the edge of the associated combustion chamber opening. The sealing beads 18 are formed as what are known as full beads with a cross section that in particular is shaped approximately in the form of the arc of a circle, wherein FIG. 1 is to represent a plan view of the concave side of each sealing bead.

In the narrow web regions of the sealing plate 10 between mutually adjacent combustion chamber openings 14, the sealing beads 18 transition into one another, as is illustrated in FIG. 1, such that two mutually adjacent sealing beads 18 in each of these web regions form only a single bead portion 18a—it is also possible, however, in principle for two mutually adjacent sealing beads 18 to be separated from one another in each of these web regions such that each of these sealing beads forms an annulus which is closed per se, which presupposes that the web region has a width sufficient for this purpose.

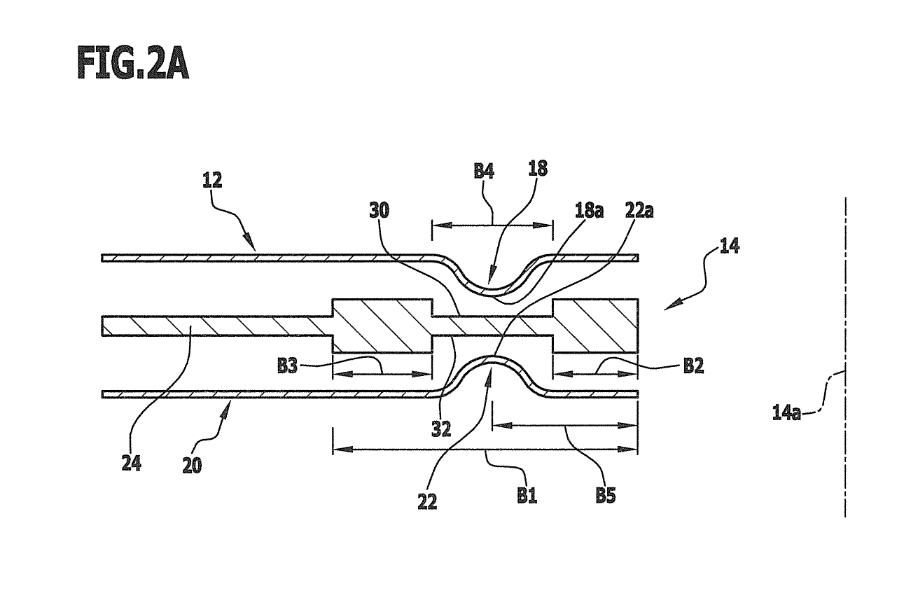

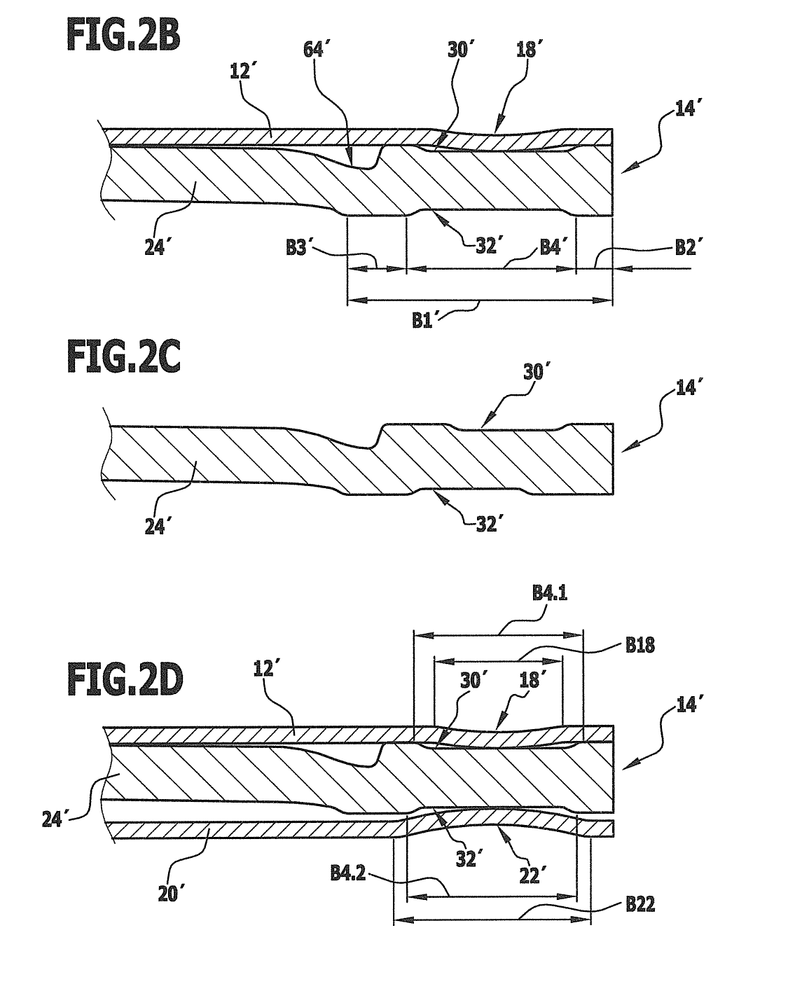

The section along line 2-2 in FIG. 1 shown in FIG. 2A through a first embodiment of the cylinder head gasket according to the invention shows, apart from the upper functional layer 12 with its sealing bead 18, also a lower functional layer 20 with a sealing bead 22 and also an inner layer 24, which is arranged between these two functional layers and which is the second sealing layer in the sense of the accompanying claims. A steel sheet formed from a relatively easily deformable, i.e. relatively ductile, steel has been used for the inner layer 24, and the inner layer 24 has an annular zone around the combustion chamber opening 14 with a radial width B1, wherein this annular zone directly borders the outer edge of the combustion chamber opening 14. This annular zone itself will also be designated hereinafter by B1.

In accordance with the invention the steel sheet used for the inner layer 24 has been deformed such that it has two thickened annular regions B2 and B3 around the combustion chamber opening 14, which annular regions are arranged at a radial spacing B4 from one another relative to an axis 14a of the combustion chamber opening 14 and the respective radial width of which annular regions will be designated hereinafter likewise by B2 and B3 respectively. The radially outer thickened annular region B3 ends at the radially outer edge of the annular zone B1, and the radially inner thickened annular zone B2 ends at the radially inner edge of the annular zone B1.

Between the thickened annular regions B2 and B3, the inner layer 24 on each of the two sides thereof thus forms an annular groove 30 and 32 running around the combustion chamber opening 14.

Radially outwardly adjacently to the annular zone B1 and in the region having the width B4 between the two thickened annular regions B2 and B3, the inner layer 24 has a thickness and a hardness corresponding at least substantially to the original thickness and the original hardness of the steel sheet used for production of the inner layer 24; by contrast, the thickened annular regions B2 and B3 have a greater thickness than the original thickness of this steel sheet, but also a greater hardness than the original hardness of this steel sheet, wherein this greater hardness is to be attributed to the fact that the thickened annular regions B2 and B3 have each been produced by a cold-forming of the steel sheet used for the inner layer 24 and this deformation was accompanied by a strain hardening of the steel, on account of which the thickened annular regions B2 and B3 have a greater hardness than the original hardness of the steel sheet used for the production of the inner layer 24.

In the case of the cylinder head gasket according to the invention illustrated in FIG. 2A, the sealing beads 18 and 22 protruding towards the inner layer 24 are arranged opposite one another and opposite the region of the inner layer 24 having the width B4 located between the thickened annular regions B2 and B3, and the radial width of the sealing beads 18 and 22 relative to the axis 14a is at most of identical size and preferably slightly smaller than the width B4. Furthermore, in preferred embodiments the radial width of the annular zone B1 is at most approximately twice the radial distance of the bead crests, designated by 18a and 22a, of the sealing beads 18 and 22 from the outer edge of the combustion chamber opening 14 (always in relation to the axis 14a).

In accordance with the description still to follow, however, the radial width of the sealing beads 18 and 20 also may be slightly greater than the width B4. In addition, it is recommended, at the radially inner and radially outer edge of each annular groove 30, to round off the thickened annular regions B2 and B3 at the transitions into their surfaces facing the functional layer 12 and the functional layer 20, such that they have no edges there, in contrast to the illustration in FIG. 2A (the same may apply where applicable to the radially inner end of the thickened annular region B2 and/or to the radially outer end of the thickened annular region B3). It is even more advantageous to form the inner layer 24 in the region of the annular groove 30 and/or of the annular groove 32 such that the cross section of the annular groove in question has a rounded portion or a radius at the transition of the groove side walls into the groove base (instead of the angular cross-sectional shape shown in FIG. 2A).

FIG. 2A shows the cylinder head gasket according to the invention in the unpressed state, wherein the spacings of the functional layers 12 and 20 from the inner layer 24, measured in the direction of the axis 14a, have been illustrated with exaggerated size. In accordance with the invention the heights to be measured in the direction of the axis 14a of the as yet unpressed sealing beads 18 and 22 are greater than the depths of the annular grooves 30 and 32 measured in this direction, wherein these heights and depths are to be dimensioned and matched to one another in accordance with the invention such that, when the cylinder head gasket is pressed and when functional layers 12 and 20 bear on both sides of the annular grooves 30 and 32 against the thickened annular regions B2 and B3, the sealing beads 18 and 22 are flattened at least substantially only reversibly, i.e. are elastically deformed (apart from a slight plastic deformation, which may or may not be present, when the gasket is installed).

In FIG. 2B the illustration corresponding to FIG. 2A of a second embodiment of the cylinder head gasket according to the invention will only be described hereinafter insofar as it differs from the embodiment according to FIG. 2A, and where possible the same reference signs as used in FIG. 2A have been used in FIG. 2B, but with the addition of a dash.

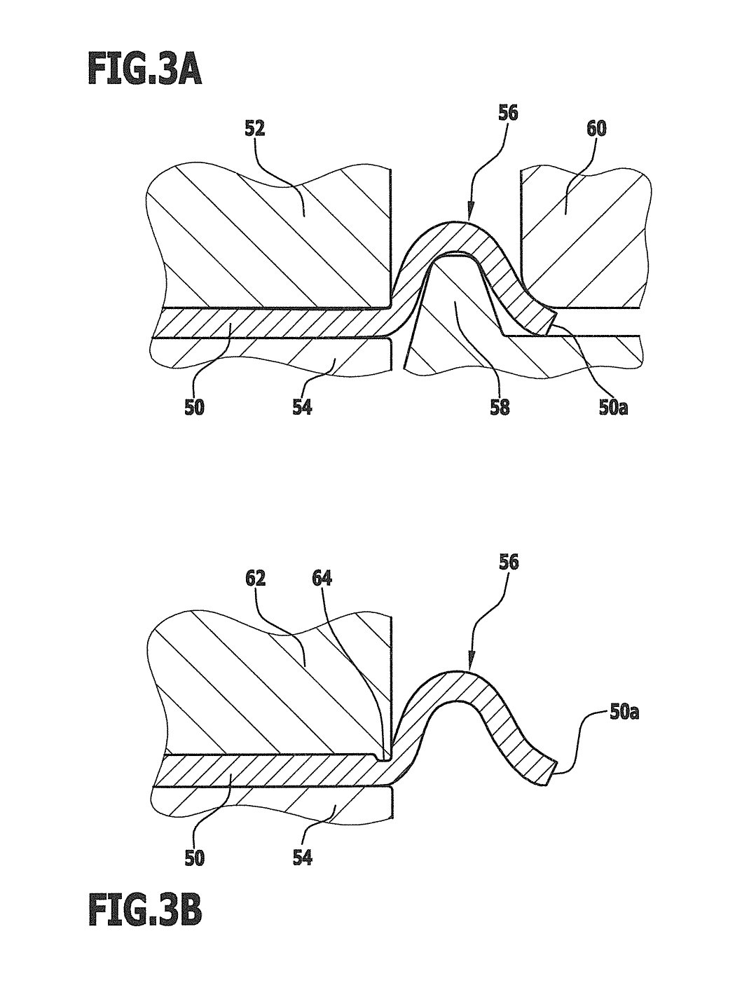

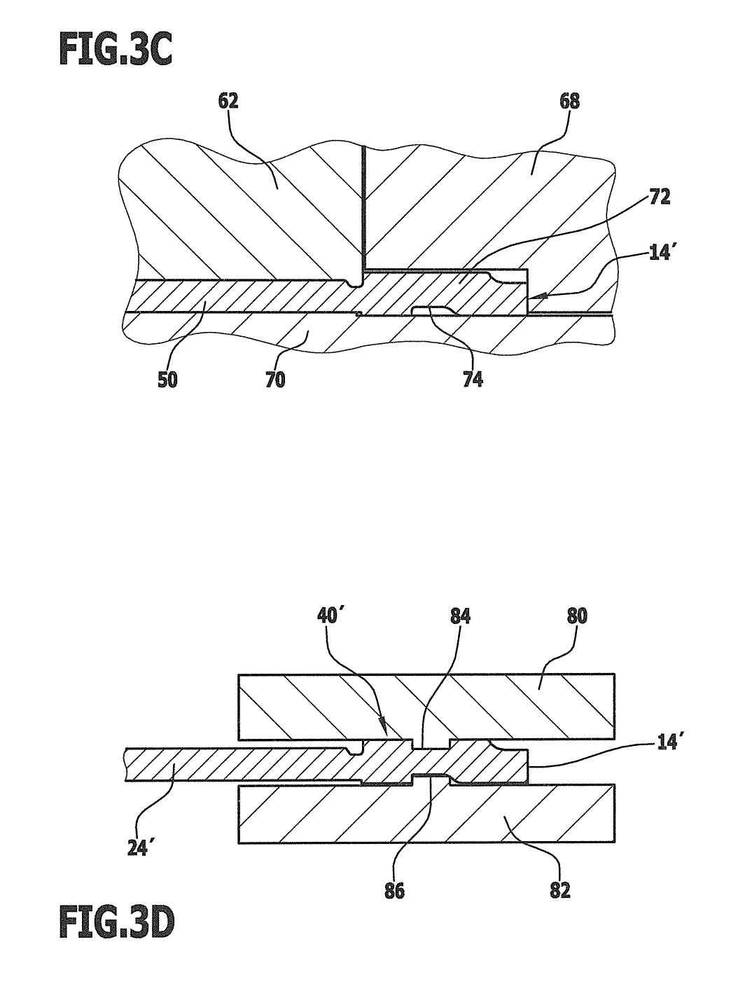

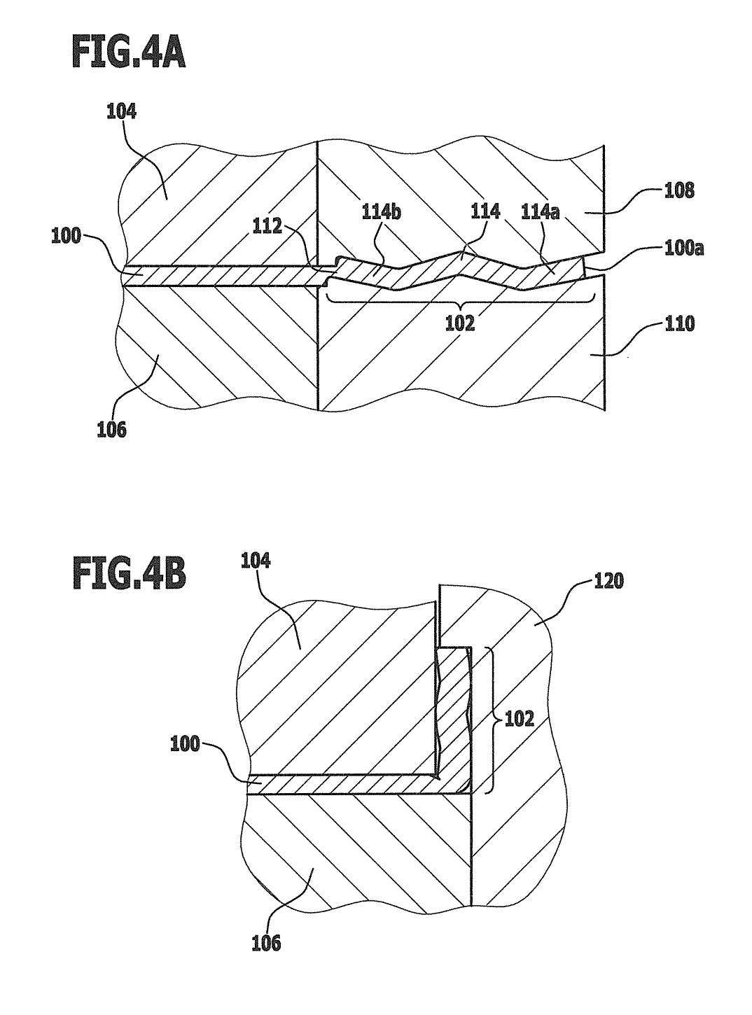

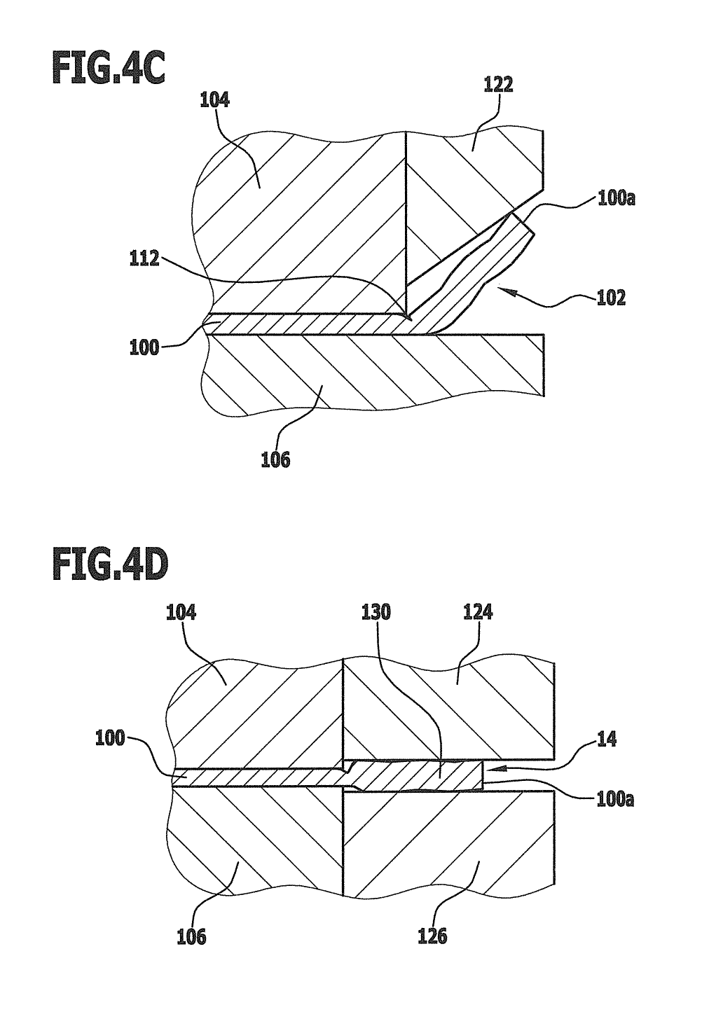

Furthermore, it is noted that preferred methods according to the invention for producing the inner layer of the cylinder head gasket illustrated in FIG. 2B will be described with reference to FIGS. 3A to 3D and FIGS. 4A to 4D.

In FIG. 2B a lower functional layer corresponding to the functional layer 20 of the embodiment according to FIG. 2A has been omitted for the sake of clarity, although the inner layer 24′ has annular grooves 30′ and 32′ between thickened annular regions B2′ and B3′ for two functional layers arranged on each of the two sides of said inner layer. In the embodiment shown in FIG. 2B, these two annular grooves have the same width, which is larger than the width of the adjacent sealing bead (wherein only one of the sealing beads, specifically the sealing bead 18′, has been illustrated), and the two annular grooves 30′ and 32′ are arranged opposite one another (in the direction of the axis of the adjacent combustion chamber opening 14′). As shown in FIG. 2B, the cross section of each of the annular grooves 30′ and 32′ is formed in this embodiment such that it is rounded in the regions of the two groove side walls, more specifically both at the transition into the groove base, but also particularly at the transition into those surfaces of the two thickened annular regions B2′ and B3′ that abut against the adjacent functional layers when the gasket has been installed; an edge pressure between the functional layers and the thickened annular regions is avoided in this way (by contrast with a design according to FIG. 2A). FIG. 2B also shows an annular groove 64′, which results from the production method yet to be described on the basis of FIGS. 3A to 3D.

The embodiments according to FIGS. 2C and 2D differ from the embodiment according to FIG. 2B only in the following manner (which is why the same reference signs have been used in all of these three Figures).

In FIG. 2C only the inner layer 24′ has been illustrated, of which the annular grooves 30′ and 32′ are formed in the same way as in the embodiment according to FIG. 2B, but in the embodiment according to FIG. 2C these annular grooves are offset from one another in the radial direction relative to the axis of the adjacent combustion chamber opening 14′, such that they only overlap one another in a plan view of the inner layer 24′. Consequently, the associated sealing beads of the two functional layers accommodating the inner layer 24′ between them must be offset from one another in the same way.

Apart from the fact that FIG. 2D shows two functional layers 12′ and 20′, FIG. 2D differs from FIG. 2B only as follows.

Whereas, similarly to the embodiment according to FIG. 2B, the annular groove 30′ has a width B4.1 which is greater than the width B18 of the sealing bead 18′, the sealing bead 22′ of the functional layer 20′ has a width B22 which is greater than the width B4.2 of the annular groove 32′—this allows the annular groove 32′ on account of its cross-sectional shape, which is rounded at the groove side walls, to avoid experiencing edge pressure in the region of the sealing bead 22′ of the functional layer 20′.

When producing the three embodiments of the inner layer 24′ illustrated in FIGS. 2B to 2D, an approach is preferably adopted such that the inner layer 24′ is firstly deformed by cold-forming, such that it has a single thickened annular region, from which the two thickened annular regions B2′ and B3′ are formed by impressing the annular grooves 30′ and 32′. Due to the forming and embossing process, the inner layer 24′ has a hardness, both in the two thickened annular regions B2′ and B3′ and in the region between the two annular grooves 30′ and 32′, that is greater than the original hardness of the steel sheet used for the production of the inner layer 24′. Since a single thickened annular region is firstly produced by cold-forming, into which the two annular grooves 30′ and 32′ are then impressed, the inner layer 24′, in its region located between these two annular grooves, has an even greater hardness there, on account of the further cold-forming and an accompanying strain hardening of this region, than in the two thickened annular regions B2′ and B3′. It must also be stressed that the above statements also apply to a modified inner layer, adjacently to which only a single functional layer is formed and which consequently has only an annular groove corresponding to the annular groove 30′ or the annular groove 32′. For the rest, the same as for the annular zone B1 of the inner layer 24 of the gasket illustrated in FIG. 2A is true for the embodiments according to FIGS. 2B to 2D in respect of their thickened annular region B1′ indicated only in FIG. 2B, their thickened annular regions B2′ and B3′, and the annular grooves 30′ and 32′.

FIG. 3A shows part of a steel sheet 50, from which the inner layer 24′ of the gaskets shown in FIGS. 2B to 2D can be produced and which is initially flat and smooth, before it is shaped by deformation, as shown in FIG. 3A. Here, the part of the steel sheet 50 from which the part of the inner layer 24′ shown in FIGS. 2B to 2D is produced is illustrated in FIG. 3A.

In a method step not illustrated in the drawings, a temporary passage opening is firstly punched out from the steel sheet 50 and later forms the combustion chamber opening 14′ of the inner layer 24′—the edge of the steel sheet 50 running around the temporary passage opening when the flat steel sheet 50 is still whole has been designated in FIG. 3A by 50a.

The left region of the steel sheet 50 according to FIG. 3A is then clamped at a radial spacing from the temporary passage opening between a tool upper part 52 and a tool lower part 54, such that this region of the steel sheet 50 cannot move, more specifically not even in the horizontal direction according to FIG. 3A, whereupon a bead-like bulge 56 surrounding the temporary passage opening in annular fashion is impressed into the steel sheet 50, more specifically by means of an embossing tool 58 movable vertically from bottom to top in accordance with FIG. 3A and by means of a hold-down device 60, which is stationary during the embossing process. During the course of the embossing of the bulge 56, the edge 50a of the steel sheet 50 according to FIG. 3A is drawn to the left and a larger passage opening corresponding approximately to the combustion chamber opening 14′ is thus produced from the temporary passage opening.

In a next method step illustrated in FIG. 3B, in which the embossing tool 58 and the hold-down device 60 have no involvement, an annular groove 64 is impressed into the upper side of the steel sheet 50 at the radially outer edge of the bulge 56 by means of an embossing tool 62, said annular groove surrounding the through-opening of the steel sheet 50.

In a further method step illustrated in FIG. 3C, on the one hand the steel sheet 50 is secured radially outside the bulge 56 with the aid of its annular groove 64 and of the embossing tool 62, and on the other hand the bulge 56 is compressed and flattened in the vertical direction, more specifically with the aid of an embossing tool 68 movable in the vertical direction and with the aid of an abutment 70. In this way, a thickened annular region 72 shown in FIG. 3C is produced from the bulge 56, which thickened annular region protrudes on both sides beyond the undeformed region of the steel sheet 50 (in the illustrated embodiment the protrusion above is much greater than below) and has smooth end faces parallel to one another above and below, which also extend parallel to the two main surfaces of the undeformed region of the steel sheet 50.

The embossing tool 68 is shaped and dimensioned such that, when the bulge 56 is compressed and flattened, i.e. when the bulge 56 is deformed into the thickened annular region 72, the latter adopts a shape and position such that the edge 50a transitions into the edge of the combustion chamber opening 14′.

As can be seen in FIG. 3C, the thickened annular region 72 on the underside thereof also has a small and flat annular groove 74, which runs around the combustion chamber opening 14′; the reason for the presence of this annular groove is considered to be the fact that when the bulge 56 is compressed and flattened the concave side thereof is not levelled completely.

In contrast to that illustrated in FIG. 3C, instead of the embossing tool 68 and the abutment 70, two tool parts may also be provided, of which the upper serves only to flatten the bulge 56 and of which the lower, however, serves not only as an abutment for the process of flattening the bulge 56, but also has a region displaceable upwardly in the vertical direction in accordance with FIG. 3C with a beveled surface that abuts against the edge 50a and when displaced upwardly enlarges the passage opening provided in the steel sheet 50 and in so doing leads over the course of the production of the annular region 72 to an additional thickening there of the steel sheet and at the same time calibrates the diameter of the combustion chamber opening 14′.

In a last step of the production method, illustrated in FIG. 3D, annular grooves 84 and 86 are impressed into the thickened annular region 72 by means of two embossing tools 80 and 82 on the upper side and the underside of said region, such that the thickened annular region B1′ of the inner layer 24′ illustrated in FIG. 2B is produced.

If necessary, the inner layer 24′ may also then be punched in order to produce the combustion chamber opening 14′ with its final diameter.

It should also be noted that the method described on the basis of FIGS. 3A to 3C can also be used in principle for a separate production of any of the thickened annular regions B2 and B3 of the gasket according to FIG. 2A (then the step described on the basis of FIG. 3D of producing the two annular grooves 84 and 86 is omitted).

Lastly, with reference to FIGS. 4A to 4D, a method will be described with which a thickened annular region can be produced similarly to the annular region 72 illustrated in FIG. 3C, into which the annular grooves 84 and 86 shown in FIG. 3D are then also impressed, by means of which, however, the radially inner thickened annular region B2 of the embodiment according to FIG. 2A or a thickened annular zone analogous to the annular zone B1′ of the embodiment according to FIG. 2B can be produced, wherein in the latter case as well annular grooves corresponding to the annular grooves 30′ and 32′ then still have to be impressed.

FIG. 4A shows a steel sheet 100 with a left undeformed region in accordance with FIG. 4A and a free, right edge 100a of a temporary passage opening produced in the steel sheet 100 and adjoined radially outwardly, i.e. to the left in accordance with FIG. 4A, by an annular zone 102, which, by contrast with that illustrated in FIG. 4A, is initially flat and smooth and transitions continuously into the left region of the steel sheet 100 in accordance with FIG. 4A.

The left region of the steel sheet 100 according to FIG. 4A not to be deformed is clamped, as shown in FIG. 4A, between clamping jaws 104 and 106, whereupon a profile is impressed into the annular zone 102 using an upper and a lower tool part 108 and 110 respectively of an embossing tool, the cross section of said profile being similar to a flat W and transitioning via a cross-sectional tapering 112 into the clamped region of the steel sheet 100. The cross-sectional profile of the annular zone 102 thus has a bulge 114 and two upwardly inclined limbs 114a and 114b.

In a method step not illustrated in the drawings the annular zone 102 is bent upwardly about the cross-sectional tapering 112 through 90°, such that a preliminary stage of the form of the steel sheet 100 shown in FIG. 4B is created. The lower clamping jaw 106 according to FIG. 4A is then shifted slightly to the right, such that it assumes the position illustrated in FIG. 4B. By means of a punch 120 shown in FIG. 4B, the annular zone 102 is then compressed transversely to the longitudinal extent thereof, specifically by displacing the punch 120 downwards into the position illustrated in FIG. 4B; the material thickness of the steel sheet 100 in the region of the annular zone 102 is thus increased, but since the latter is trapped between the punch 120 and the clamping jaw 104, the steel sheet of the annular zone 102 cannot warp or bulge considerably in the horizontal direction according to FIG. 4B.

The envisaged increase of the material thickness of the steel sheet 100 in the region of the annular zone 102 presupposes, however, that the steel sheet 100, prior to the displacement of the punch 120 according to FIG. 4B downwards between said punch and the clamping jaw 104, has a clearance necessary for the desired material thickness increase; as a result of this, the steel sheet 100 in the region of the annular zone 102 warps slightly over the course of the material thickness increase, i.e. the compression of the steel sheet, as has been indicated in FIG. 4B. Due to the profiling of the annular zone 102 illustrated in FIG. 4A, the steel sheet 100 in the event of compression of the annular zone 102 warps or ripples at points predefined by this profiling. It has now been shown that, during the course of the above-described compression of the steel sheet 100 in the annular zone 102 thereof and the accompanying warping, the material of the steel sheet 100 flows in regions such that it is advantageous to slightly offset from one another the annular grooves 30′ and 32′ shown in FIGS. 2B to 2D, similarly to the illustration in FIG. 2D.

As illustrated in FIG. 4C, the annular zone 102 is pivoted downwards again about the cross-sectional tapering 112 by means of a punch 122 and is then compressed between two tool parts 124 and 126 shown in FIG. 4D in a direction perpendicular to the undeformed region of the steel sheet 100, such that a compact thickened annular region 130 is created, which may correspond to the thickened annular region B2 of the embodiment according to FIG. 2A. As shown in FIG. 4D, the cross section of the thickened annular region 130 corresponds approximately to a rectangle, and the thickness of this thickened annular region is much greater than the thickness of the original steel sheet 100.

Similarly to the production method described with reference to FIGS. 3A to 3D, in the method according to FIGS. 4A to 4D the edge 100a defining the combustion chamber opening 14 or 14′ at the end moves with the method steps shown in FIGS. 4A to 4B in the direction of the undeformed region of the steel sheet or of the sealing layer, such that a larger final media-passage opening or combustion chamber opening is provided from a temporary passage opening initially formed in the steel sheet.

All embodiments therefore have the common feature that the material for producing the least one thickened annular region of a flat gasket according to the invention is recovered from the free end of the second steel sheet used for the inner layer or the second sealing layer, said free end defining the temporary passage opening produced initially.

A key advantage or an essential feature of the invention also lies in the fact that the radially inner and the radially outer stopper of a double stopper according to the invention may readily have different thicknesses or heights and/or one of the stoppers or both stoppers may have a height profile or different height profiles respectively, since for this purpose only the embossing tool 68 or at least one of the embossing tools 80 and 82 or at least one of the tool parts 124 and 126 has to be correspondingly configured.

1. A metallic flat gasket comprising a gasket plate having at least one media-passage opening and having, in the region of the media-passage opening, at least one spring steel functional layer formed of a first steel sheet with a sealing bead that surrounds the media-passage opening and is formed as a full bead with a bead crest arranged between two bead feet, and also a second gasket layer, which is directly adjacent to the functional layer and is formed of a second steel sheet, which is more easily deformable compared with spring steel, which second gasket layer has, around the media-passage opening, an annular zone adjacent thereto and, radially outwardly adjacently to said annular zone relative to the media-passage opening, has an original thickness and an original hardness of the second steel sheet, wherein the second gasket layer in its annular zone has at least one annular region that is thickened compared with the original thickness of the second steel sheet, which thickened annular region extends along the sealing bead in a plan view of the gasket plate and on the side of the second gasket layer facing towards the functional layer forms an annular groove, in which the sealing bead engages with its bead crest when the flat gasket is pressed, wherein the second gasket layer in the thickened annular region produced by deforming areas of the second steel sheet has a greater hardness, based on a strain hardening in said areas of the second steel sheet on account of the deformation, than the original hardness of the second steel sheet, and wherein
(a) the annular zone has only one thickened annular region, into which an annular groove is impressed on at least one side of the second gasket layer, or
(b) the annular zone has, in the radial direction relative to the media-passage opening, two thickened annular regions arranged one behind the other and spaced apart from one another which form the annular groove between them.

2. The flat gasket according to claim 1, in which the second gasket layer is arranged directly between two spring steel functional layers, each of which has a sealing bead surrounding the media-passage opening, wherein the least one thickened region forms an annular groove on each side of the second gasket layer, and when the flat gasket is pressed the sealing beads engage with their sealing crests in these annular grooves.

3. The flat gasket according to claim 2, wherein, in a section through the gasket plate along a plane containing the axis of the media-passage opening, the annular grooves of the two layer sides are offset from one another in the radial direction relative to this axis, and in that the sealing beads of the two functional layers are offset from one another in the same manner.

4. The flat gasket according to claim 3, wherein, in a plan view of the gasket plate, the annular grooves provided on the two layer sides overlap one another.

5. The flat gasket according to claim 1, in which the second gasket layer, between the two mutually spaced thickened annular regions, has at least approximately the original thickness and the original hardness of the second steel sheet.

6. The flat gasket according to claim 1, in which the at least one thickened annular region on both sides of the second gasket layer protrudes beyond the region of the second gasket layer radially outwardly bordering the annular zone.

7. The flat gasket according to claim 1, in which the radial width of the annular zone relative to the media-passage opening is at most approximately twice the radial spacing of the bead crest from the outer edge of the media-passage opening.

8. The flat gasket according to claim 1, in which the thickened annular region extends as far as the outer edge of the media-passage opening.

9. The flat gasket according to claim 1, in which the width of the annular groove is the same size as or larger than the width of the sealing bead associated with this annular groove.

10. The flat gasket according to claim 9, in which the depth of the annular groove is dimensioned such that, when the flat gasket is pressed and when a functional layer bears in sealing operation on each side of the annular groove against the at least one thickened annular region, the sealing bead is deformed exclusively reversibly, i.e. elastically.

11. A method for producing a metallic flat gasket comprising a gasket plate having at least one media-passage opening and having, in the region of the media-passage opening, at least one spring steel functional layer formed of a first steel sheet with a sealing bead that surrounds the media-passage opening and is formed as a full bead, and also a second gasket layer, which is directly adjacent to the functional layer and is formed of a second steel sheet, which is more easily deformable compared with spring steel, which second gasket layer has, around the passage opening, an annular zone adjacent thereto and radially outwardly adjacently to said annular zone relative to the media-passage opening, has an original thickness of the second steel sheet, wherein the second gasket layer in its annular zone has at least one annular region that is thickened compared with the original thickness of the second sheet steel, which thickened annular region extends along the sealing bead in a plan view of the gasket plate and on the side of the second gasket layer facing towards the functional layer forms an annular groove, in which the sealing bead engages with its bead crest when the flat gasket is pressed, wherein, in order to produce the thickened annular region, a temporary passage opening concentric with the media-passage opening to be produced in the second steel sheet used for the second gasket layer is made in said second steel sheet, the diameter of said temporary passage opening being smaller than that of the media-passage opening, whereupon the second steel sheet is compressed from the edge of the temporary through-opening, such that a blank of the thickened annular region is produced, and this blank is brought by embossing into the form of the thickened annular region.

12. A method for producing a metallic flat gasket comprising a gasket plate having at least one media-passage opening and having, in the region of the media-passage opening, at least one spring steel functional layer formed of a first steel sheet with a sealing bead that surrounds the media-passage opening and is formed as a full bead, and also a second gasket layer, which is directly adjacent to the functional layer and is formed of a second steel sheet, which is more easily deformable compared with spring steel, which second gasket layer has, around the passage opening, an annular zone adjacent thereto and, radially outwardly adjacently to said annular zone relative to the media-passage opening, has an original thickness of the second steel sheet, wherein the second gasket layer in its annular zone has at least one annular region that is thickened compared with the original thickness of the second sheet steel, which thickened annular region extends along the sealing bead in a plan view of the gasket plate and on the side of the second gasket layer facing towards the functional layer forms an annular groove, in which the sealing bead engages with its bead crest when the flat gasket is pressed, wherein, in order to produce the thickened annular region, a temporary passage opening concentric with the media-passage opening to be produced in the second steel sheet used for the second gasket layer is made in said second steel sheet, the diameter of said passage opening being smaller than that of the media-passage opening, whereupon a bulge surrounding the temporary passage opening in an annular fashion is impressed into the second steel sheet such that hereby the outer edge of the temporary passage opening is drawn radially outwardly, and the region of the second steel sheet provided with the bulge is brought by embossing into the form of the thickened annular region.

13. The method according to claim 11, in which the annular groove is impressed into the thickened annular region.

14. The method according to claim 12, in which the annular groove is impressed into the thickened annular region.

15. The method according to claim 11, in which two thickened annular regions are produced in the second steel sheet at a radial spacing from one another relative to the media passage opening, which annular regions accommodate the annular groove between them.

16. The method according to claim 12, in which two thickened annular regions are produced in the second steel sheet at a radial spacing from one another relative to the media passage opening, which annular regions accommodate the annular groove between them.

17. The method according to claim 15, wherein the radially inner thickened annular region relative to the media-passage opening is produced in accordance with claim 11 and the radially outer thickened annular region is produced in accordance with claim 12.

18. The method according to claim 16, wherein the radially inner thickened annular region relative to the media-passage opening is produced in accordance with claim 11 and the radially outer thickened annular region is produced in accordance with claim 12.

19. The method according to claim 15, wherein both thickened annular regions are produced in accordance with claim 12.

20. The method according to claim 16, wherein both thickened annular regions are produced in accordance with claim 12.
